(19) United States
(12) Patent Application Publication
(10) Pub. No.: US 2007/0067455 A1
(43) Pub. Date: Mar. 22, 2007

(54) Dynamically adjusting resources

(75) Inventors: Dennis Gursky, Bothell, WA (US); Yevgeniy Samsonov, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/199,457

(22) Filed: Aug. 8, 2005

(51) Int. Cl. G06F 15/173

(52) U.S. Cl. 709/225

(57) ABSTRACT

Computer resources are dynamically adjusted based on the frequency of user input. A process monitors the user input and adjusts the resource utilization level for a managed process based on the period of time since the last user input. The more recent the user input, the less processing is performed by the managed process and the more the process sleeps. The more distant the user input, the more processing is performed by the background process and the process sleeps less. Even during constant and frequent user input, however, the managed process continues to perform some work.

### BACKGROUND

The use of computer resources for applications is rarely constant. At some points the use of computer resources may be very low, while at other points, the usage of resources for an application can rise to a level that can adversely affect the performance of other applications. During the time the utilization is high, users may notice their system responding slowly to their commands. This can especially become a problem when a user becomes frustrated and stops working due to the limited resources available to processing their actions. During the times the use of computer resources are idle, on the other hand, other processes may utilize the available computing resources to perform work without adversely affecting a user's experience. In order to avoid the slowdown that is noticed by users when the usage becomes high, many applications performing operations in the background completely stop working when an application in the foreground is utilizing resources. This approach is known as a total back-off approach for managing resources, such as CPU and I/O resources. One such application type that may use this total back-off approach is desktop indexing systems. This total back-off approach means that when an indexer detects user activity and/or CPU load it immediately stops indexing files and waits a period of time without activity before resuming indexing. In some implementations an indexer may also monitor CPU load and only index after it becomes lower than a predefined threshold. This total back-off approach to managing resources allows the foreground processes to operate without interference from the background processes.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Computer resources are dynamically adjusted based on user input. In response to user input, a resource utilization level is determined that is used to control the computer resources utilized by one or more managed processes. The managed processes being controlled are typically background processes that do not receive user input during their processing. The resource utilization level is set such that the computer resources used by the managed process do not negatively impact a user's experience when they are interacting with another application. Generally, the more recent the user input was received, the fewer computer resources are utilized by the managed process. The less recent the user input was received, the more computer resources are utilized by the managed process. Even during constant and/or very recent user input, however, the managed process continues to utilize at least some of the computer resources.

### BRIEF DESCRIPTION OF THE DRAWINGS

FIG. 1 illustrates an exemplary computing device;

FIG. 2 illustrates a resource utilization system;

FIG. 3 shows a process for dynamically adjusting computer resources in response to user input;

FIG. 4 illustrates determining the resource utilization level based on user input; and

FIG. 5 illustrates an exemplary time line illustrating user input based resource setting, in accordance with aspects of the present invention.

### DETAILED DESCRIPTION

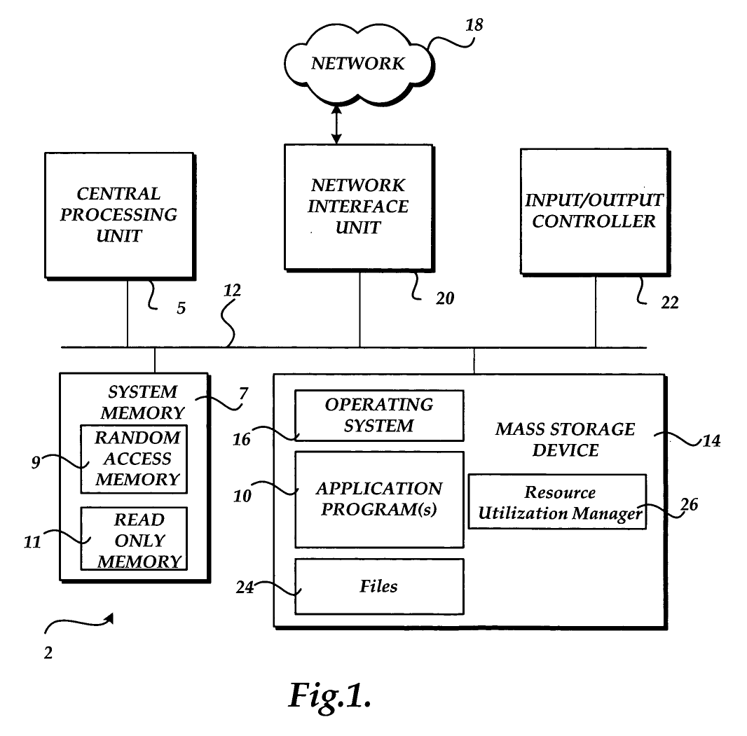

Referring now to the drawings, in which like numerals represent like elements, various aspects of the present invention will be described. In particular, FIG. 1 and the corresponding discussion are intended to provide a brief, general description of a suitable computing environment in which embodiments of the invention may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 2 utilized in various embodiments will be described. The computer architecture shown in FIG. 1 illustrates a conventional desktop or laptop computer, including a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The computer 2 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 2. Although the description of computer-readable media contained herein refers to a mass storage device, such as a hard disk or CD-ROM drive, the computer-readable media can be any available media that can be accessed by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 18, such as the Internet. The computer 2 may connect to the network 18 through a network interface unit 20 connected to the bus 12. The network interface unit 20 may also be utilized to connect to other types of networks and remote computer systems. The computer 2 may also include an input/output controller 22 for receiving and processing input from a number of other devices, including a keyboard, mouse, a touch screen, a trackball, electronic stylus, and the like (not shown in FIG. 1). Similarly, an input/output controller 22 may provide output to a display screen, a printer, or other type of output device.

As mentioned briefly above, a number of program modules and data files may be stored in the mass storage device 14 and RAM 9 of the computer 2, including an operating system 16 suitable for controlling the operation of a networked personal computer, such as the WINDOWS XP operating system from MICROSOFT CORPORATION of Redmond, Washington. The mass storage device 14 and RAM 9 may also store one or more program modules. In particular, the mass storage device 14 and the RAM 9 may store application program 10. According to one embodiment, the application program 10 is operative to receive input from a user. The application program, however, may be any type of program. For instance, email programs, web browsers, word-processing programs, desktop publishing programs, presentation programs, and any other type of programs that require resources from computer 2. Other programs that do not receive user input may also be executed on computer 2.

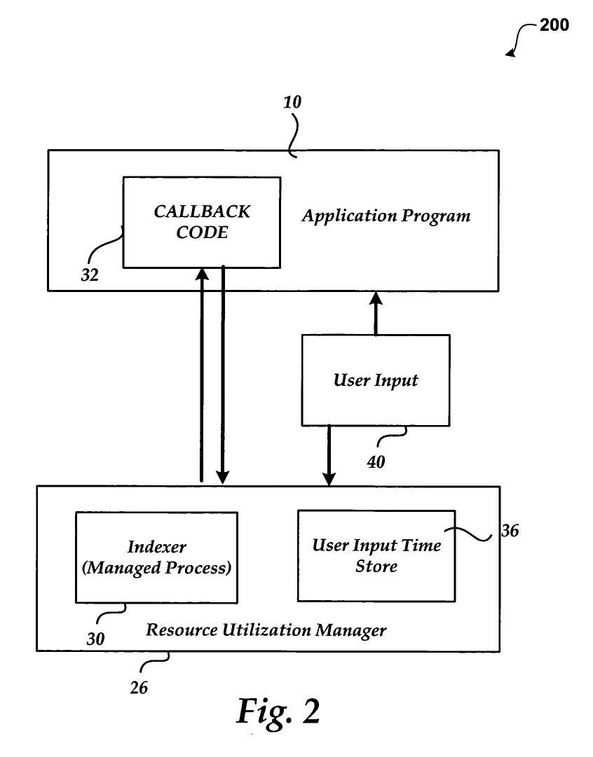

Resource utilization manager 26 is configured to dynamically adjust a computer's resources, such as computer 2's resources. As will be described in greater detail below, resource utilization manager 26 dynamically adjusts the use of the computer's resources based on the user input received through input/output controller 22. In particular, resource utilization manager 26 performs an algorithm to determine the period of time since the most recent user input and uses this time period to set a resource utilization level. The resource utilization level determines the computer resources that are utilized by a managed process. According to one embodiment, the managed process is an indexing application (See FIG. 2) that is configured to index the files 24 on a computer. Any program(s), however, may be managed. Generally, any program or process that utilizes a computer's resources may be managed. Typically, a managed application is an application that needs to perform at least some of its operations in the background while other processes may be running. Additional details regarding the operation of resource utilization manager 26 will be provided below.

FIG. 2 illustrates a resource utilization system 200, in accordance with aspects of the invention. FIG. 2 provides additional details regarding the interaction between a client application that receives user input, such as application program 10, the resource utilization manager 26, and a managed process 30. As described briefly above, the resource utilization manager 26 dynamically adjusts the use of the computer's resources for one or more managed processes 30 based on user input 40.

User input 40 may be monitored by resource utilization manager 26 directly or indirectly. For example, resource utilization manager 26 may receive the user input from the operating system. According to another embodiment, resource utilization manager 26 may monitor all the user input received or may receive information about the user input from one or more application programs, such as application program 10. In order to facilitate the communication between application program 10 and resource utilization manager 26, application program 10 may implement one or more callback routines, illustrated in FIG. 2 as callback code 32. Through the use of the callback code 32, the resource utilization manager 26 may query the application program 10 for information regarding the user input. User input time store 36 is configured to record the time of the most recent user input.

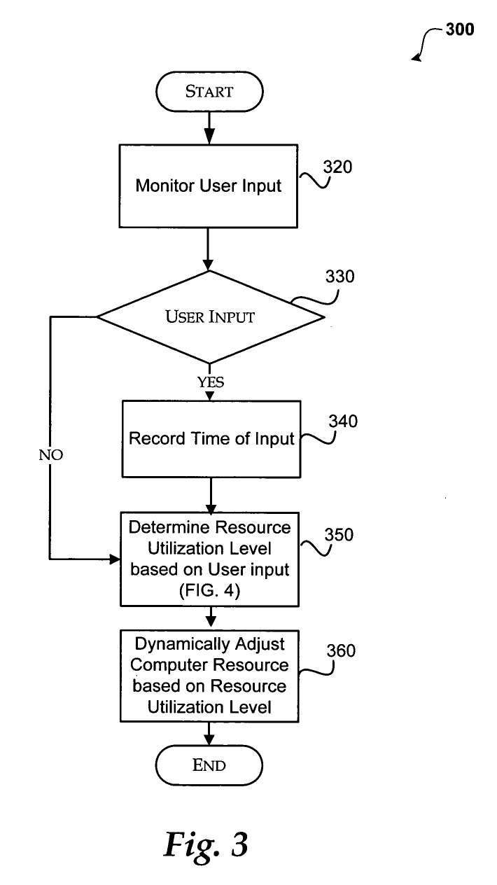

Resource utilization manager 26 is arranged to determine a resource utilization level in response to the user input 40. According to one embodiment, the resource utilization level is one of three levels, including: unlimited, recent, and limited processing. Other resource utilization levels may be used. For example, the resource utilization level could be a percentage, a ratio, or more or less discrete levels. Generally, the resource utilization level is set such that the computer resources used by the managed process do not negatively impact a user's experience when they are interacting with an application that is not managed. Fewer computer resources are utilized by the managed process 30 when the user input was recently received. More computer resources are utilized by the managed process 30 when the user input was more in the past. Even during constant and/or very recent user input, however, the managed process continues to utilize some of the computer resources (See FIGS. 3-5 and related discussion).

According to one embodiment, the managed process is indexer 30 that is configured to index files on a user's computer. Typically, an indexing system indexes the most common file types on a system such that a search may be performed to locate a particular file. The created index allows a user to quickly locate specific words or phrases in e-mail messages, calendar appointments, documents, photos, and other files on the computer. The index also contains information, such as the time a file was created and its file type. The index is updated whenever a new file is added/deleted and/or change is made to a file or message.

Any process or combination of process, however, may be a managed process. Indexer 30 is configured to run in the background while it is indexing files and is managed by resource utilization manager 26 such that its interference with application program 10 is not significant when application 10 is being utilized by a user. A significant interference would be interference that causes the system to react slowly to a user's input such that it is noticeable to the user. Since indexer 30 uses some of the computer's processing power to build and maintain the desktop index, a user may notice a change in their computer's response time while the indexer is running if it were not managed. If the indexer 30 uses too much of the computer's processing power a user may become frustrated.

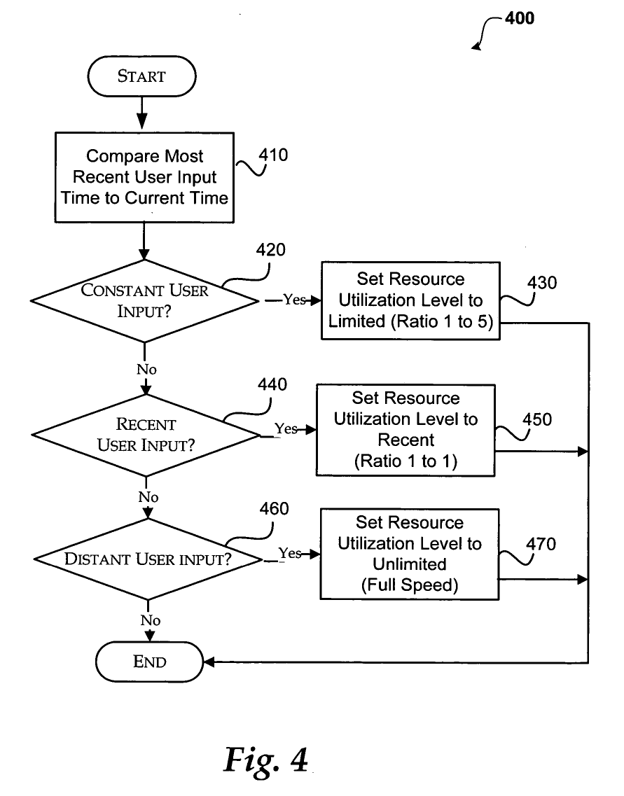

Referring now to FIGS. 3 and 4, an illustrative process for dynamically adjusting computer resources based on user input will be described.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments of the described herein are referred to variously as operations, structural devices, acts or modules. These operations, structural devices, acts and modules may be implemented in software, in firmware, in special purpose digital logic, and any combination thereof.

FIG. 3 shows a process for dynamically adjusting computer resources in response to user input, in accordance with aspects of the invention.

After a start operation, the process flows to operation 320 where user input is monitored. According to one embodiment, any type of user input is monitored. For example, keyboard input, mouse input, trackball input, pointer input, pen input, touchpad input, touch screen input, and the like are monitored. Generally, any type of user input that is supported by the computing device is monitored. According to another embodiment, the user input may be limited to monitoring user input related to a specific application(s) and/or a specific user input device(s).

Moving to decision operation 330, a determination is made as to whether a user input has been received. When a user input has not been received, the process flows to operation 350. When user input has been received, the process flows to operation 340 where the time of the received user input is recorded. The time of the user input may be recorded in any manner such that the time period from the user input may be determined. For example, the time may be recorded based on a current clock time, a current counter time, and the like.

Transitioning to operation 350, the resource utilization level is determined. Generally, the resource utilization level is set such that the managed process utilizes fewer resources the more recent the user input was received and utilizes more resources the farther in the past the user input was received. Even during constant and/or very recent user input, however, the managed process continues to utilize some of the computer resources. According to one embodiment, one of three resource utilization levels is determined based on the time between user inputs (See FIG. 4 and related discussion).

Moving to operation 360, the computer resource is dynamically adjusted based on the determined resource utilization level. The adjusted resource will be set at the current level until a new user input is recorded that affects the determination of the resource utilization level.

The process then moves to an end operation where the process returns to processing other actions.

FIG. 4 illustrates determining the resource utilization level based on user input, in accordance with aspects of the present invention.

After a start operation, the process flows to operation 410 where the most recent user input time is compared to the current time. This comparison produces a time since the last user input was received.

Moving to decision operation 420, a determination is made as to whether the user is in a constant user input state. According to one embodiment, a constant user input state is when the last user input occurred less than five seconds ago. Many other time periods may be used. For example, the time period may be one second, 500 ms, ten seconds, twenty seconds, and the like, depending on the application. When the user input is determined to be in a constant user input state, the process flows to operation 430 where the resource utilization level is set to limited. Even during the constant user input state, the managed process, such as the indexer described above, is permitted to perform a limited amount of work. When the resource utilization level is set to limited, the process works only a small fraction of the time. According to one embodiment, the work to sleep ratio is one to five. For example, during a one second time period the managed process will work for about 0.17 seconds and sleep for 0.85.

When the user input is not determined to be in a constant user input state, the process flows to decision operation 440, where a determination is made as to whether the user input is recent. According to one embodiment, a recent user input state is when the last user input occurred more than five seconds ago but less than thirty seconds ago. Many other time periods may be used. When the user input is determined to be in a recent user input state, the process flows to operation 450 where the resource utilization level is set to recent. During the time the resource utilization level is set to recent, the managed process performs work half of the time and sleeps the other half. This work to sleep ratio may be configured based on the demands of the application. Generally, more work will be performed by the managed process when the resource utilization level is set to recent as compared to constant.

When the user input is not determined to be in a recent user input state, the process flows to decision operation 460, where a determination is made as to whether the user input was distant. According to one embodiment, user input is in a distant user input state when the last user input occurs more than thirty seconds ago. Many other time periods may be used depending on the time parameters used in the other states. When the user input is determined to be distant, the process flows to operation 470 where the resource utilization level is set to unlimited. According to one embodiment, during the time the resource utilization level is set to unlimited, the managed process, such as the indexer, performs work as fast as it can. In other words, there are no forced sleep periods. A ratio of sleep to work, however, may be utilized when the resource utilization level is set to unlimited. The work to sleep ratio may be configured for each of the resource utilization levels based on the demands of the application.

The process then moves to an end block and returns to processing other actions.

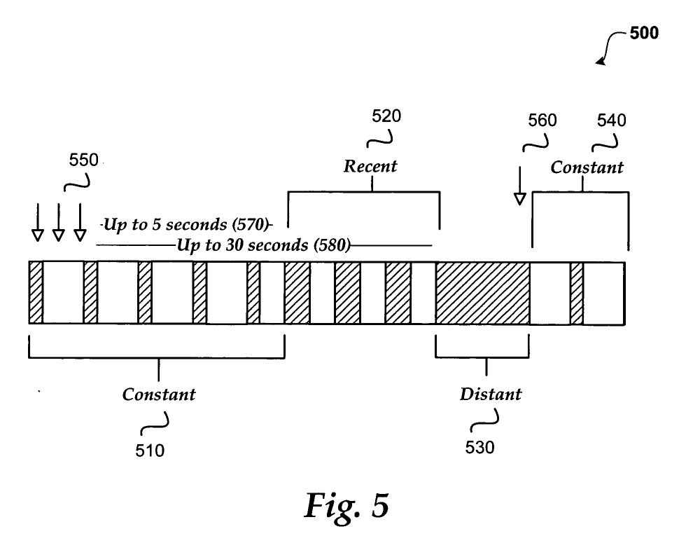

FIG. 5 illustrates an exemplary time line 500 illustrating user input based resource setting, in accordance with aspects of the invention. As illustrated, timeline 500 includes constant user input state 510, recent user input state 520, distant user input state 530 and another constant user input state 540. Also shown are user inputs 550 and user input 560. The areas that are hatched within the timeline show when work is performed during the state. The areas that are not hatched show the period of time the managed process is sleeping and not performing work.

A constant user input state 510 shows user input 550 occurring continuously or in the very recent past. According to one embodiment, a constant user input state is any period in which the last user input occurred less than five seconds ago (570). As discussed above, this time cutoff may be set too many different points. For example, the time period cutoff may be one second, 500 ms, ten seconds, twenty seconds, and the like. Although not shown to scale, it can be seen that the time a process works during a constant user input state is significantly less than the time it sleeps. As illustrated, the ration is approximately one work unit to four of five sleep units.

A recent user input state 520 illustrates user input 550 occurring recently but not recently enough to be considered continuous. According to one embodiment, the recent user input state is user input that has been received from five seconds in the past to less than thirty seconds in the past (570, 580). During the recent user input state the work to sleep ratio is approximately equal or may be set differently if desired.

A distant user input state 530 illustrates a full speed phase where the user input was received in the past. According to one embodiment, any user input received more than thirty seconds ago is considered distant (580). During the distant user input state, work for the managed process occurs at full speed. A work to sleep ratio may be introduced in the distant user input state if desired. Generally, the process will work more than it sleeps when the user input state is set to the distant user input state.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for dynamically adjusting computer resources, comprising:
monitoring user input; and
dynamically adjusting a computer resource that is associated with a managed process based on the user input; wherein the managed process continues to perform at least some work independent of the user input.

2. The method of claim 1, wherein dynamically adjusting the computer resource that is associated with the managed process comprises adjusting a work to sleep ratio based on how recent the user input was made, wherein the work to sleep ratio includes a work unit that is larger than zero.

3. The method of claim 2, further comprising recording a time of the user input and using the time to determine a resource utilization level that is associated with the managed process and is used to control the amount of processing performed by the managed process.

4. The method of claim 3, wherein determining the resource utilization level comprises determining when the user input state is at least one of a constant user input state, a recent user input state, and a distant user input state.

5. The method of claim 4, wherein the work to sleep ratio is set to approximately one work unit to five sleep units when the user input is determined to be in the constant user input state.

6. The method of claim 4, wherein the work to sleep ratio is set to approximately one work unit to one sleep unit when the user input is determined to be in the recent user input state.

7. The method of claim 4, wherein determining when the user input state is the constant user input state comprises determining when the user input occurs approximately less than five seconds in the past.

8. The method of claim 4, wherein determining when the user input state is the recent user input state comprises determining when the user input occurs approximately between five seconds and thirty seconds in the past.

9. The method of claim 4, wherein determining when the user input state is the distant user input state comprises determining when the user input occurs approximately more than thirty seconds in the past.

10. A computer-readable medium having computer-executable instructions for dynamically adjusting computer resources, comprising:
monitoring user input;
determining a time that is associated with the user input; and
dynamically adjusting the processing performed by a managed process based on the time of the user input; wherein the managed process continues to perform at least some processing independent of the time of the user input.

11. The computer-readable medium of claim 10, wherein dynamically adjusting the processing comprises determining a resource utilization level and determining a processing level based on the resource utilization level.

12. The computer-readable medium of claim 11, wherein determining the resource utilization level comprises setting the resource utilization level to one of: limited, recent, and unlimited.

13. The computer-readable medium of claim 11, further comprising setting a work to sleep ratio based on the resource utilization level, wherein the work to sleep ratio increases as the time of the user input moves farther into the past.

14. The computer-readable medium of claim 11, wherein dynamically adjusting the processing performed by the managed process based on the time of the user input comprises: setting the processing to approximately twenty percent when the user input is determined to be constant; setting the processing to approximately fifty percent when the user input is determined to be recent, and setting the processing to approximately one hundred percent when the user input is determined to be distant.

15. The computer-readable medium of claim 12, further comprising setting the resource utilization level to limited when the user input occurs approximately less than five seconds ago; setting the resource utilization level to recent when the user input occurs between approximately five seconds and thirty seconds in the past; and setting the resource utilization level to continuous when the user input occurs approximately more than thirty seconds in the past.

16. A system for dynamically adjusting computer resources, comprising:
an input controller arranged to receive user input for an application;
a managed process that is configured to index files; and
a resource utilization manager configured to perform actions, including:
receiving information regarding the user input;
determining a time that is associated with the user input from the received information; and
adjusting the processing performed by the managed process based on the time of the user input; wherein the managed process continues to perform at least some processing independent of the time of the user input.

17. The system of claim 16, wherein adjusting the processing comprises adjusting the processing such that less processing is performed by the managed application when user input is recently received.

18. The system of claim 16, wherein adjusting the processing comprises determining a resource utilization level and determining a processing level based on the resource utilization level.

19. The system of claim 16, further comprising wherein adjusting the processing comprises setting a work to sleep ratio based on the resource utilization level, wherein the work to sleep ratio increases at least once as the time of the user input moves farther into the past.

20. The system of claim 18, wherein determining the resource utilization level comprises setting the resource utilization level to one of at least two levels.
